(19) United States
(12) Patent Application Publication
(10) Pub. No.: US 2009/0013063 A1
(43) Pub. Date: Jan. 8, 2009

(54) METHOD FOR ENABLING INTERNET ACCESS TO INFORMATION HOSTED ON CSD

(75) Inventor: ANAND KESHAV SOMAN, Pune (IN)

Correspondence Address: ANAND KESHAV SOMAN, A-32 ABHIMANSHREE SOCIETY, PASHAN ROAD, PUNE, 411008, IN

(73) Assignee: Mrs. NIRALI SANGHI, PLEASANTON, CA (US)

(21) Appl. No.: 11/772,246

(22) Filed: Jul. 2, 2007

(51) Int. Cl. G06F 15/173

(52) U.S. Cl. 709/223

(57) ABSTRACT

The disclosure describes a method for enabling internet access to information hosted on a computer or a storage device (CSD), even without having a web server software on the CSD. The CSD is registered with a server and assigned an ID by the server. Information about all CSDs is stored in a database on the server. A unique resource locator (URL) is created for each file intended to be shared. The URLs of all hosted files are stored in a file called the registry file residing on the CSD. An intending recipient may enter the URL of the desired file in a web browser. The URL is sent from the web browser to the server. The server forwards the URL to the CSD The file is retrieved from the CSD and sent to the server. The server forwards the file to the recipient computer, where the web browser displays it.

This application claims priority to and incorporates by reference provisional application No. 60/836,165 filed on Aug. 8, 2006, provisional application No. 60/854,683 filed on Oct. 27, 2006, and provisional application No. 60/874,535 filed on Dec. 13, 2006.

### BACKGROUND OF THE INVENTION

Web Servers are Computers on the Internet that host resources such as files, HTML pages, web-services etc, and allow access to the hosted resources from other computers connected to the Internet via protocols such as HTTP, FTP, etc. Usually, Web Servers are high-end machines, running relatively complex software, and require a ‘real’ Internet Protocol Address (IP Address). This ‘real’ IP Address is what allows them to be accessible from other computers on the Internet. Most Personal Computers such as those in offices and homes are unable to function as Web Servers because they do not have ‘real’ IP Addresses. This in turn is because they are behind routers or firewalls that do Network Address Translation (NAT). The number of Personal Computers behind a particular router/firewall may be more in number than the number of static IP Addresses assigned to that router/firewall, making it impossible for each Personal Computer behind the router/firewall to have a unique static or real IP Address. In other situations, the Internet Protocol (IP) Address of Personal Computers is dynamically assigned by the Internet Service Provider, and can change from time to time. For the above reasons, most individual users prefer to web-host their content with Internet Service Providers.

We present an invention to provide commonly required Web Server functionality from Personal Computers, Laptop Computers, Handheld Computers, etc. The Web Server functionality continues to work from behind of routers/firewalls/proxys that perform Network Address Translation or when the IP Address of the Personal Computer changes dynamically. The Personal Computer running our Web Server only needs to be able to access the Internet; but having a ‘real’ or ‘static’ IP Address is not a requirement. We also present a method for implementing the Search Capability on content that is hosted on a multitude of such Web Servers.

Our invention allows a large number of computers to function as Web-Servers, which they could not do earlier.

### SUMMARY

The disclosure describes a method for enabling internet access to information hosted on a computer (e.g., a desktop computer, a laptop computer, a PDA, a server, etc.) or a storage device (e.g., a hard derive, a flash memory, a pen drive, etc.) Conventionally, information to be given access to over the internet is typically hosted on a web server. However, the method disclosed herein describes a method for hosting files on any computer or storage device, even without having a web server software on the computer or the storage device.

In an embodiment of the method, a computer or a storage device is registered with a server. During the registration process, the server assigns an ID (also called the CSD ID) to the computer or the storage device. Information about all registered computers or storage devices is maintained in a database residing on the server.

A unique resource locator (URL) is created for each file intended to be made available to the public over the internet. The files may be hosted on a computer or a storage device. The unique resource locators and other pertinent information about all hosted files are stored in a file called the registry file residing on the computer or the storage device as the case may be.

The computer or the storage device may identify itself to the server using the assigned ID and establish a communication channel with the server. An intending recipient may enter the URL of the desired file in a web browser in the recipient's computer. The URL is sent from the web browser of the recipient's computer to the server over the internet. The server parses the URL to identify the computer hosting the file corresponding to the URL. The computer hosting the file looks up the file in the file registry and sends it to the server. The server forwards the file to the web browser in the recipient computer.

In another embodiment, a crawler software may reside on the server and obtain the files hosted on all computers and/or storage devices registered with the server. An indexer software may index the obtained files to create an indexed database. A search query engine may search the indexed database to return results in response to a search string entered by a user.

In another embodiment, there may be multiple servers to service a large number of users. A load balancer may route incoming requests on a single IP Address to one out of the multiple servers to distribute the load of the incoming requests uniformly without overloading a particular server.

In another embodiment, communication between the server and the host computer may be managed securely by using (a) public-private key pairs, and/or (b) a server program residing on the server; and/or (c) a program residing on the host computer or the storage device.

In another embodiment, access to the hosted files can be regulated dynamically. For example, it may be possible to define the number of permitted accesses for any hosted file. Once this limit is exceeded, access to the file will be disabled. It may also be possible to enable or disable the access to any file dynamically.

In another aspect of the invention, the disclosure describes a system for enabling internet access to information hosted on a computer or storage device. The system may include a computer or storage device (CSD) hosting one or more files, a server connected to the CSD over the internet and having a handshake server program for managing communication with the CSDs, and a recipient computer having a web browser and connected to the server over the internet. The system may also include a CSD program residing on the CSD for (a) managing communication with the server, and/or (b) generating unique resource locators for the hosted files, and/or (c) maintaining a record of all the hosted files in a registry file residing on the CSD. The system may also include a CSD database residing on the server and including records of all the CSDs registered with the server.

### BRIEF DESCRIPTION OF THE PREFERRED EMBODIMENTS

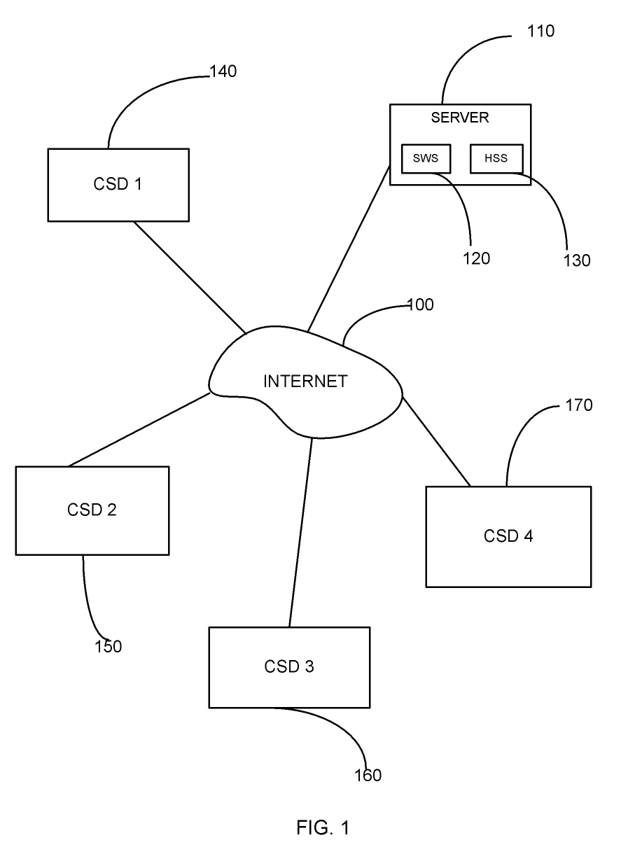

FIG. 1 shows an overview of an embodiment of an invention disclosed herein.

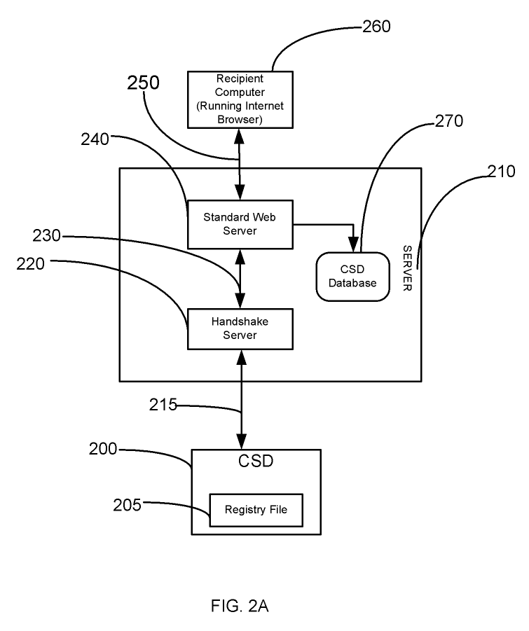

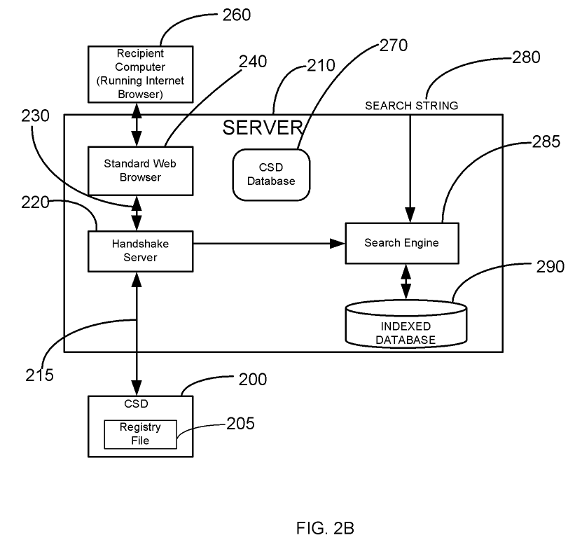

FIG. 2 A-B show different embodiment of the invention. The description covers a multiplicity of embodiments, some of which are discussed in the specification.

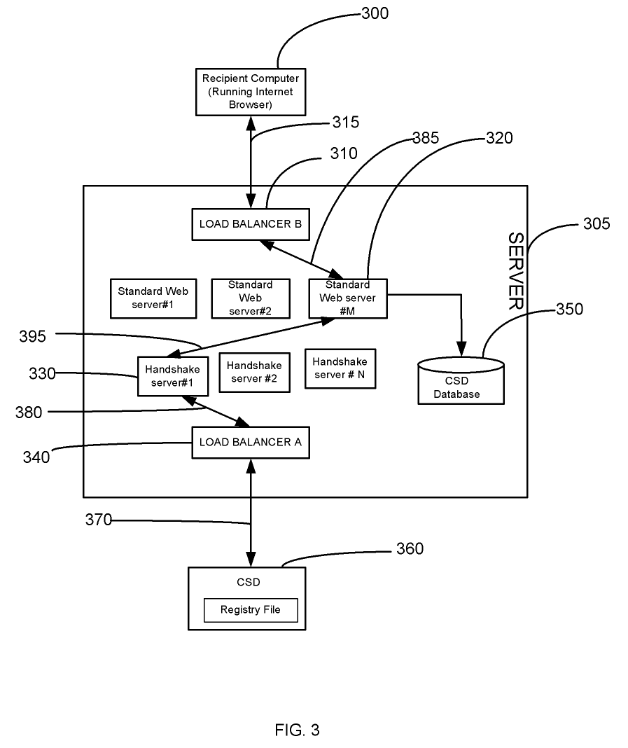

FIG. 3 shows yet another embodiment of an invention disclosed herein. The embodiment herein discloses server architecture to support a large number of users.

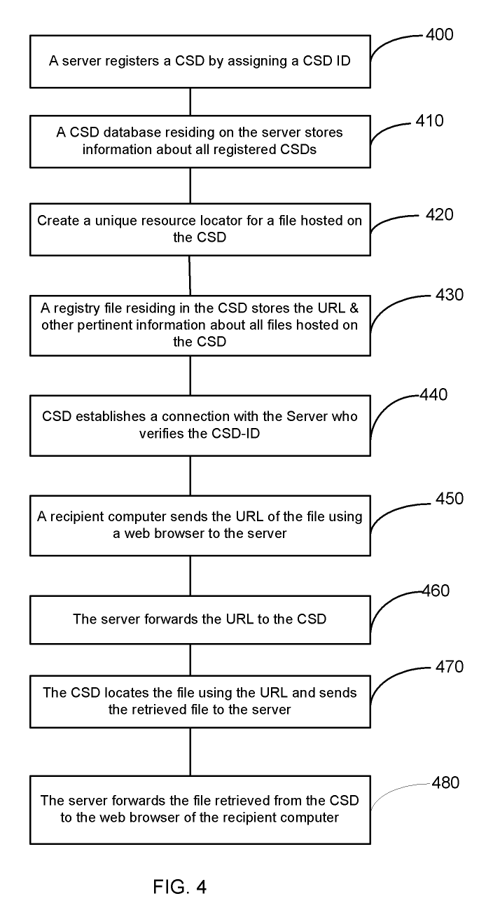

FIG. 4 discloses a flow diagram of registration process of a CSD with a server of an embodiment of the invention.

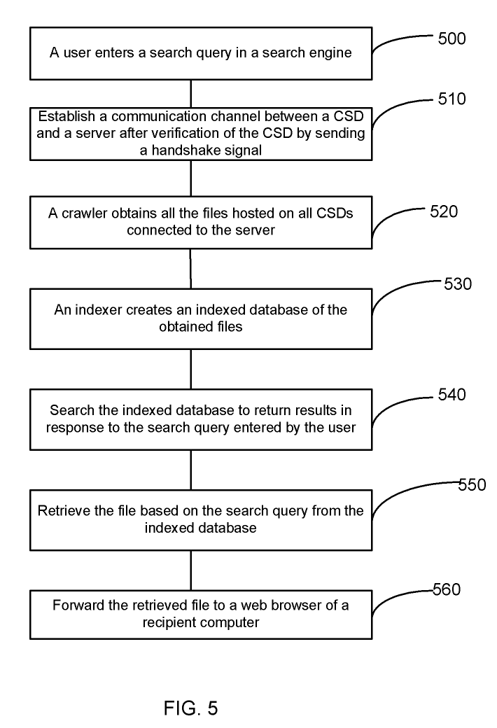

FIG. 5 discloses a flow diagram of a search mechanism an embodiment of the invention.

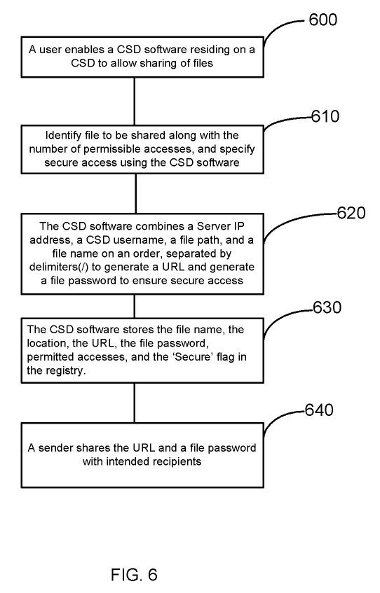

FIG. 6 discloses a flow diagram of generation of a URL for a file to be searched from a CSD in an embodiment of the invention.

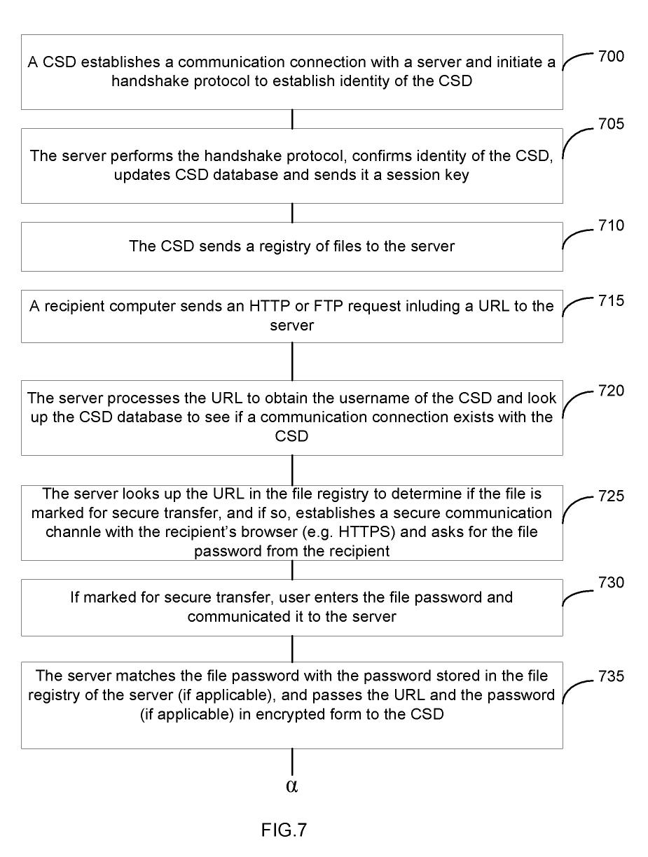

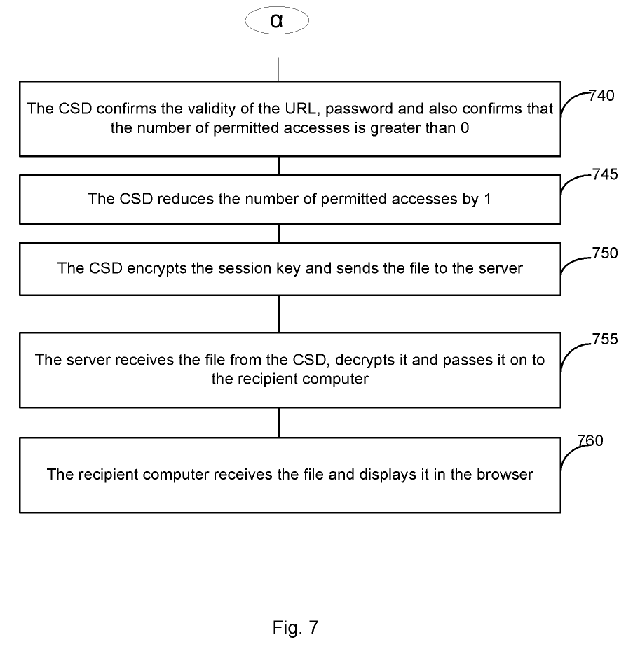

FIG. 7 discloses a flow diagram of overall process of an embodiment of the invention.

### DETAILED DESCRIPTION OF THE PREFERRED EMBODIMENTS

In the following description of various embodiments including the preferred embodiments, reference is made to the accompanying drawings, which show by way of illustration the embodiments in which the invention may be practiced. It is to be understood that other embodiments may be utilized and structural and functional modifications may be made without departing from the spirit or scope of the invention. Those skilled in the art will readily appreciate that the detailed description given herein with respect to these drawings is for explanatory purposes as the invention extends beyond these limited embodiments.

FIG. 1 shows an overview of an embodiment of an invention disclosed herein. The inventions discloses a server 110 connected through an internet 100 to other computing and/or storage devices (hereinafter called CSDs) 140-170 using their internet protocol addresses. Examples of computing and/or storage devices 140-170 can be computer servers, mainframe computers, personal computers, laptops, handheld computers, storage devices, smart drives including ‘pen-drives’, etc. The server 110 may include either one or both of a standard web server 120 (hereinafter called the SWS) and/or a handshake server 130 (hereinafter called the HSS). Examples of the SWS 120 can be commercially available web server software such as Microsoft™ IIS, Apache from Apache Software Foundation, etc. The SWS 120 and the HSS 130 can be accessible from any other CSD connected to the internet 100 using their internet protocol address. The SWS 120 and the HSS 130 can share a common IP address but they can have different port numbers. Any CSD wishing to host and share files have to first “register” with the server 110. The process of registration involves allocation of a unique CSD ID to the CSD. Based on CSD IDs, identification of any CSDs can be done by the server 110. CSD IDs can also be required for establishing secure communication between the CSDs and the server 110. In an embodiment of the invention, the CSD ID may include a username, credentials (such as but not limited to passwords, public private key, etc.) and the IP Address/Domain name of the server 110. The CSD IDs of all the registered CSDs may be stored in a CSD database on the server 110. The CSD database is a database residing on the server 110 containing all the information pertaining to the registered CSDs.

There can be several ways to define the credentials. In the simplest form, these credentials could be a secret password known to the particular CSD and the server 110. This password could be used by the CSD to identify itself to the server 110, and encrypt communication between the CSD and the server 110. A more sophisticated example of the CSD credentials can be assignment of a Public-Private Key pair to the CSD along with the Public Key of the server 110. Here, public keys and private keys denote the keys of a public-key algorithm such as the Rivest Shamir Adelman (RSA) algorithm.

In an embodiment of the invention, a sender wishing to share a file present on say CSD 140, he can launch a program on the CSD 140 called a CSD program. The CSD program may have an interface that allows the sender to identify the file he wants to share. For each such file identified for sharing, the CSD program generates an access tag. An access tag can be a unique identifier for each file that is shared.

FIG. 2 A-B show different embodiment of the invention. The description below covers a multiplicity of embodiments, some of which are discussed herein. However, it is to be noted that a plurality of embodiments may be described using the same figure and reference numerals.

FIG. 2 A shows an embodiment of the invention, which includes a CSD 200, connected with a server 210. The server 210 includes a handshake server 220 and a standard web server 240, and a CSD database 270. The handshake server 220 communicates with the CSD 200 through a communication connection 215. The CSD 200 includes a registry file 205, which contains all the relevant information, such as URL of the file, location of the file, number of permitted accesses, and the status of the file i.e. “shared”, “unshared”, “enabled”, “disabled,” etc. about the files to be shared by the CSD 200. The standard web server 240 can be connected with the handshake server 220 through a communication channel 230. A recipient computer 260 can access the standard web server 240. The CSD database 270 is a database, which keeps all the information about the registered CSDs, their URLs, their usernames, passwords and public private key pairs.

The CSD 200 initiates and maintains active communication connection 215 with the handshake server 220.

An intended recipient enters a URL of a file hosted by the CSD 200 in an internet browser residing on the recipient computer 260. An HTTP request is then communicated over an internet connection 250 to a server 210. The server 210 receives the URL and parses the CSD ID from the URL, and then looks it up in its CSD database 270 to determine if the CSD 200 is presently active. If it is, the server 210 forwards the URL to the CSD 200, over the communication channel 215 with the CSD 200. The CSD looks up its registry file 205 to determine if a file corresponding to such a URL has been hosted on the CSD 200. If such a URL entry exists in the registry file 205, the CSD 200 returns that file to the server 210. The server 210 forwards it to the recipient's computer 260 and fulfills the request of the recipient's computer 260. If the CSD ID of the CSD 200 is not present as active in the CSD database 270, or if the URL is not present in the registry file 205 of the CSD 200, a message is returned to the recipient's computer 260 stating invalidity of the URL.

The operations described above ensure that the files on the CSD 200 can be accessed from the recipient's computer 260 via the server 210, as long as the CSD 200 can access the Internet. In this manner, the CSD 200, which could be any Computer, Laptop, Handheld, or even a smart storage device.

FIG. 2 B shows another embodiment of the invention wherein a user enters a search string 280 which is sent to a search engine 285 residing on the server 210. The search engine 285 sends a request to a handshake server 220 through a communication channel to retrieve all relevant content files hosted on different CSDs. The search engine 285 indexes all the retrieved content files and populates an indexed database 290. The server 210 returns the results back to the user.

In other embodiments, when a sender wishes to host a file present on the CSD, he may launch a CSD program (not shown) on the CSD 200. For every such file identified for hosting by the sender, the CSD program may generate an ‘access tag’. The access tag may be a unique identifier for every file that is hosted. The CSD program may ensure that the same access tag has not been allotted to another previously hosted file from the CSD 200.

There are several ways to ensure the uniqueness of the access tag. In one embodiment, the access tag may select the name of the file itself (either including or without its directory path). The inclusion of the directory path automatically ensures uniqueness of the access tag. In another embodiment, uniqueness may be ensured by appending some unique random characters to the filename before the file extension.

For example:—
http://<Server IP Address>/<CSD Username>/filename.ext
http://<Server IP Address>/<CSD Username>/<directory path>/filename.ext
http://<Server IP Address>/<CSD Username>/<directory path>/filename<XX>.ext
The front slash character ‘/’ is a commonly used delimiter in URLs. ‘XX’ refers to a number of unique random characters. The server domain name may be used instead of its IP address.

The CSD program (not shown) may then create a ‘Unique Resource Locator’ or ‘URL’ for the file by combining the access tag, the CSD ID, and the IP address of the server 210. The CSD program (not shown) may store the name of the file along with its directory path (i.e. location), and its corresponding URL in the registry file 205. The CSD Program (not shown) also may also allow the user to disable access to a previously hosted file.

An intended recipient wishing to access a file may enter the URL into a web browser of the recipient computer 260. It can be possible that at the time of entering the URL, there can be a change in the IP address of the CSD 200. There can be several factors responsible for the change in the IP address such as power off, allocation of a different dynamic IP address, change in location of the CSD with different IP service provider, etc., but any of the factors cannot restrict the communication and transfer of file from the CSD 200 to the recipient computer 260.

In an embodiment, the CSD 200 may go through a process of a “Handshake Protocol” with the server 210. With the help of the handshake server 220, the CSD 200 initiates and establishes a channel for two-way communication with the server 210. The CSD 200 can authentically identify itself to the server 210. The server 210 maintains a record of the CSD usernames, their active status, i.e. whether the CSD 200 has presently opened a communication channel with the server 205 or not with the help of the CSD database 270.

In another embodiment of the invention, a sender can be allowed to specify the number of permitted accesses for each file using a CSD program (not shown). The number of permitted accesses specified for each file can be stored in the registry file 205 present in the CSD 200 and the number may be decreased by one every time the file is accessed. If the number of permitted accesses becomes zero, the CSD program cannot sent the required file to a recipient computer.

In yet another embodiment, a sender can be allowed to “enable” or “disable” the sharing of the file at any time on a CSD 200, with such enablement information also being stored in the registry file 205 present in the CSD 200. The CSD program will return files with valid URLs only if they are “enabled” at the time they are sought to be accessed.

In another embodiment of the invention, a CSD 200 communicates details of its registry file 205 to a server 210 each time a handshake protocol takes place after an initial handshake protocol. The server 210 maintains copies of the information in the registry files 205 of all the CSDs that are active in its CSD database 270. In such a situation, the server 210 can look up the URL received from the intended recipient in the registry file 205 based on the CSD ID parsed from the URL, and only forward the URL to the CSD 200 if it exists in its copy of the registry file 205. In this scheme, the CSD 200 sends a message to the server 210 making modification to the registry file 205 and copy on the server 210 every time a change is made to the registry file 205 on the CSD 210. The advantage of this enhancement is that it filters any spurious URL requests from reaching the CSD 200.

Yet another embodiment of the invention requires the CSD 200 to communicate its registry file 205 to the server 210 every time it is connected, after the initial handshake protocol. The server 210 maintains copies of the registry files 205 of all the CSDs that are active in its CSD Database 270.

Another embodiment of the invention permits the sender to specify the hosted file as ‘secure.’ In this embodiment, the CSD program on the CSD 200 also generates a random file password for the file along with the URL (or allows the sender to specify a file password). This file password can also be stored in the registry file 205 corresponding to each ‘secure’ file. The intended recipient needs to enter the file password when he wants to access the file using the URL. The server 210 forwards the file password along with the URL to the CSD 200, and the CSD 200 returns the file only if this file password matches with the one stored in the registry file 205 for this file. In case of such secure files, the file returned by the CSD 200 to the server 210 can be encrypted with the session key. The server 210 decrypts it and forwards it to the intended recipient.

Another embodiment of the invention can be for the CSD program to compress files before they can be sent to the server 210, and for the server 210 to decompress them before forwarding them to the recipient. The compression and decompression can be done by any of the well-known lossless compression algorithms. The benefit of such compression is faster communication of data between the CSD 200 and the server 210, because less data needs to be communicated.

Another embodiment can be to allow the CSD program to generate multiple URLs for the same hosted file, with the multiple URLs being all stored in the registry file 205 associated with a single file on the CSD 200. Each of these URLs can then be provided to different groups of intended recipients. This allows the sender to track which group of intended recipients has been accessing the file.

FIG. 3 shows yet another embodiment of an invention disclosed herein. The embodiment herein discloses server architecture to support a large number of users. The server architecture includes a recipient computer 300, a CSD database 350 and a CSD 360, and a server 305 including at least a pair of load balancers ‘A& B’ 340, 310, a set of standard web servers 320, and a set of handshake servers 330.

In the present embodiment, the load balancer ‘A’ 340 and load balancer B 340 balances the load in between a set of standard web server 320 and a set of handshake server 330 respectively. The load balancers ‘A&B’ 340,310 can be a hardware that diverts incoming requests on a single IP address to one out of the multiple resources in order to distribute the load of the incoming requests uniformly without overloading any particular resource. The load balancer allows the connection requests to be made to a single IP address although a set of physical resources may be serving requests arising from different CSDs.

The CSD 360 connects to the internet and executes CSD program. The CSD program establishes a connection with the load balancer ‘B’ 310 using a known domain name/IP address of the handshake server 330. The load balancer ‘B’ 310 diverts the connection request to any handshake server from the available set of handshake servers 330. The CSD 360 establishes a persistent communication connection 370, 380 with one of the handshake server 330 using the load balancer ‘B’ 310. The CSD database 350 maintains a record of which specific handshake server 330 the CSD 360 with a particular CSD username is connected.

Similarly, the load balancer ‘A’ 340 balances the load occurring on the standard web server 320. A recipient enters a URL of hosted content into an internet browser residing on a recipient computer 300. The internet browser on the recipient computer 300 establishes a connection 315 with the load balancer ‘A’ 340, which forwards the connection 385 to an available standard web server from the set of standard web server 320. The standard web server 320 parses the CSD username from the URL, and looks up in its active CSD database to determine which handshake server 330 caters to the CSD 360. After determining the specific handshake server 330, the standard web server 320 redirects the URL to the specific handshake server 330 by making a connection 395. The handshake server 330 obtains the content file from the CSD 360 and returns the content file as descried previously to the standard web server 320. The standard web server forwards the content file to the intended recipient over connections 375 and 385.

Examples of Handshake Protocol are possible, and two possibilities are described below.

Handshake Protocol 1:

When the Credentials of the CSD comprise only a secret Password, the CSD communicates to the Server its Username and a pre-designated code encrypted with this secret Password. The Server decrypts it with the same secret Password (which it already has in its CSD Database), verifies the correctness of the pre-designated code and sends back to the CSD a ‘Session Key’ also encrypted with the secret Password. The Session Key can thereafter be used to encrypt further communication between the Server and the CSD in this session, i.e., until the Handshake Protocol is re-executed between the CSD and the Server.

Handshake Protocol 2:

When the Credentials of the CSD comprise its Public-Private key pair and the Public key of the server, the following protocol can be used. The CSD first sends the server a ‘Handshake Signal’ which involves sending to the server the Username of the CSD along with a ‘certificate’ that establishes the identity of the CSD with the server. One example of such a certificate is to compose the certificate of: (i) a number randomly generated by the CSD (called ‘Random Number-A’), together with (ii) the same random number (‘Random Number-A’) ‘signed’ by the private key assigned to the CSD at the time of its registration. The username along with this certificate is further encrypted with the public key of the server to ensure that only the server can read the handshake signal contents. The server upon receipt of this handshake signal, decrypts its contents with its own private key to obtain the username of the CSD, and then looks up the public key corresponding to the username stored in its CSD Database. This is used to verify that the signed random number within the certificate after authentication with the CSD public key matches with the plainly stated random number ‘Random Number-A’ in the certificate. If this verification is successful, the identity of the CSD is established and the server sends a ‘Handshake Acknowledgement’ to the CSD. This Handshake Acknowledgement comprises a session Key, the random number sent by the CSD as a part of the handshake (‘Random Number-A’) and a server certificate, all together encrypted with the public key of the CSD. The server certificate itself is created with two parts (i) a number randomly generated by the server (‘Random Number-B’) together with (ii) the same randomly generated number (‘Random Number-B’) ‘signed’ by the private key of the server. Upon the receipt of the handshake acknowledgement, the CSD Program decrypts it using its own private Key. It verifies that the random number being returned by the server (‘Random Number-A’) is same as the random number it had sent to the Server as a part of the Handshake Signal. It stores the session key sent by the server for further use and also verifies the server certificate. This process of verification of the server certificate involves ensuring that the signed random number after authentication with the server public key matches with the plain random number (‘Random Number-B’) presents in the server certificate. The session key can be used to encrypt further communication between the server and the CSD in this session, i.e., until the Handshake Protocol is re-executed between the CSD and the Server. Finally, to close the Handshake Protocol, the CSD sends to the server a ‘Connection Continue’ signal, comprising its username, and the ‘Random Number-B’ encrypted with the session key. The receipt of this ‘Connection Continue’ signal is an indication to the server that the CSD is authentic and that the files stored on it are now ready to be accessed using their URLs. The server therefore marks this CSD as ‘active’ in its CSD Database. If either the certificate sent by the CSD cannot be authenticated by the server or the certificate sent by server cannot be authenticated by the CSD, or if the random number in the Connection Continue signal received by the Server does not match ‘Random Number-B’ the connection is not established.

Normally, a disconnection of a CSD from the Internet (or termination of the CSD Program) is detected by the server from the breakage of the communication channel established by the CSD between itself and the server. Such a detection of disconnection forces the server to mark that CSD as ‘inactive’ in its CSD Database. Therefore, the server at any given time has information of all the CSDs accessible over the Internet along with their communication channels with itself. In most common manifestation, the communication channel over the Internet is a ‘Socket’ established by the CSD with the server. When a CSD is active, i.e., has a communication connection established with the server, the CSD Program is able to receive and process any messages from the server.

Because all communication between the CSD and the server is over such a channel (socket) established by the CSD, the server does not need to establish a connection with the CSD on its own. Therefore, the CSD may change its IP Address or not even have a static or ‘real’ IP Address. All it needs to do is to initiate and perform the Handshake Protocol after establishing a communication channel (socket) to the server whenever it connects to the Internet.

When the intended recipient wants to access the File, he enters the URL to into any standard Internet Browser on his computer. Since the first part of the URL is the IP Address/Domain name of the server, the Internet Browser directs the request to the server. The server receives the URL and parses the username from the URL, and then looks it up in its CSD Database to determine if the CSD is presently active. If it is, the server forwards the URL to the CSD, over the communication channel with this CSD. The CSD looks up its registry to determine if a File corresponding to such a URL has been shared from the CSD. If such a URL entry exists in the registry file, the CSD returns that file to the server. The server forwards it to the recipient's computer by means of fulfilling the Internet Browser request. If the Username of the CSD is not present as active in the CSD Database, or if the URL is not present in the registry file of that specific CSD, a message is returned to the recipient's computer stating invalidity of the URL.

The operations described above ensure that the files on the CSD can be accessed from the recipient's Internet Browser via the server, as long as the CSD can access the Internet. In this manner, the CSD, which could be any computer, laptop, handheld, or even a smart storage device can be made to provide the common functionality of a web server, i.e., sharing files.

FIG. 4 discloses a flow diagram of an embodiment disclosed herein.

In step 400, a CSD wishing to host a file and which is connected through an internet with a server can get registered with the server. The process of registration involves allocation of a unique CSD ID to the CSD by the server. In addition to the CSD ID, the server may also assign “credentials” (such as, but not limited to, a secret password, a public-private key pair, etc.), which may be used to authenticate any CSD by the server over the internet and perform a secure communication between the CSD and the server.

In step 410, for every CSD registered, the server maintains a record of the CSD ID and the CSD credentials in a database called the CSD database. The CSD database stores all the credentials, CSD IDs, and other parameters of the CSD.

In step 420, a sender identifies a file to be hosted on the CSD and generate a unique resource locator (URL) for the file. The unique resource locator may be created by combining an access tag, the CSD ID, and the IP address of the server. The access tag is a unique identifier for every file that is hosted. A delimiter (/) may separate the IP address, the CSD ID and the access tag in the URL.

In step 430, a registry file residing in the CSD stores the URL, and other pertinent information about all files hosted on the CSD.

In step 440, the CSD establishes a connection with the server who verifies the CSD-ID. The server verifies the CSD ID and a communication channel may be established between the CSD and the server by sending a handshake protocol. After the handshake protocol, file sharing process between the CSD and the recipient computer can be initiated.

In step 450, a recipient enters the URL of the file, which he wants to retrieve using the web browser residing on his/her computer. The recipient computer sends the URL of the file to the server.

In step 460, the server after receiving the requested URL from the recipient computer forwards it to the CSD.

In step 470, the CSD locates the file using the URL and sends it to the server. In an embodiment, the CSD also checks the access tag of the file. For example, if the file is marked with the “share” tag only then may it be sent to the server.

In step 480, the server receives the file from the CSD and forwards the retrieved file to the web browser of the recipient computer.

FIG. 5 discloses a flow diagram of an embodiment disclosed herein.

In step 500, a recipient enters a search query in a web browser residing on the recipient computer, and the recipient computer then sends the search query to a search engine installed on a server.

In step 510, a communication channel may be established between the CSD and the server by using a handshake protocol. The server verifies the CSD ID and initiates the file sharing process between the CSD and the recipient computer.

In step 520, a crawler, which could be a part of the search engine, may obtain all the files hosted on all CSDs registered and connected with the server. It may give a command to the handshake server to query all the connected CSDs to send to the handshake server the content files presently hosted by them. All the connected CSDs send their hosted content files to the handshake server, which stores them in local storage in the server.

In another embodiment of the invention, the handshake server may maintain a database of the names and URLs of all the content files that are presently hosted on all the CSDs with currently active connection. This database can be called the URL Database. The search engine may then use the URL database to obtain the hosted files individually by submitting the URLs to the handshake server for fetching the corresponding content files, to index them, and to populate the indexed database. When a new content file is hosted on a CSD, the CSD may immediately communicate its name and URL to the handshake server for populating the URL database, and the search engine may index it as described above. When a content file is un-hosted, the CSD may communicate this fact to the handshake server, which may delete the entry from the URL database. Before any results of the search are to be displayed to a user in response to a search string, the search engine may ensure that the content files corresponding to the search results are listed in the URL database, i.e., are hosted on a CSD with a currently active connection.

In another embodiment of the invention, there may be a ‘master server’ communicating with a multiplicity of servers. Each of the servers may have their own family of CSDs connected to them. If a user enters a search string, the master server may communicate the search string to the multiple servers each of whom may be running their own search engines; each search engine may return its search answers to the master server, which may consolidate and display the results.

In step 530, the indexer, which is another part of the search engine may index these content files and create an indexed database.

In step 540, the server may have a user interface wherein the user can input the search string. After receiving the search string, the indexed database can be queried to return the names and URLs of the content files that match the search string.

In step 550, the server may retrieve the files from the indexed data base.

In step 560, the server may forward the files retrieved from the indexed database to the web browser of the recipient computer.

FIG. 6 discloses a flow diagram of an embodiment disclosed herein.

In step 600, a sender who wishes to host a file may launch a CSD program residing on the CSD.

In step 610, the sender may identify the files to be hosted along with the number of permissible accesses for each file, and may also specify secure access using the CSD program residing on the CSD.

In step 620, the CSD program may combine a server IP address, a CSD ID, a file path, and a file name separated by delimiters (/) to generate a URL and a file password to ensure secure access.

In step 630, the CSD program may store the file name, the location, the URL, the file password, permitted accesses, and the “secure” flag in a file registry.

In step 640, a sender may share the URL and a file password with the intended recipients.

FIG. 7 discloses a flow diagram of an embodiment disclosed herein.

In step 700, a CSD may establish a communication connection with a server and initiate a handshake protocol to establish identity of the CSD.

In step 705, the server may perform the handshake protocol, confirm the identity of the CSD, update CSD database, and send it a session key.

In step 710, the CSD may send a file registry to the server.

In step 715, a recipient computer may send an HTTP or FTP request including a URL to the server.

In step 720, the server may process the URL to obtain the CSD ID and look up the CSD database to see if a communication connection exists with the CSD.

In step 725, the server may look up the URL in the file registry to determine that the file is marked for secure transfer, and if so, establishes a secure communication channel with the recipient's browser (e.g. HTTPS) and asks for the file password from the recipient.

In step 730, if marked for secure transfer, a user enters the file password and communicates it to the server.

In step 735, the server matches the file password with the password stored in the file registry of the server (if applicable), and passes the URL and the password (if applicable) in encrypted form to the CSD

In step 740, the CSD may confirm the validity of the URL, password and confirms that the number of permitted accesses is greater that zero.

In step 745, the CSD may reduce the number of permitted accesses by one.

In step 750, the CSD may encrypt the session key and send the file to the server.

In step 755, the server may receive the file from the CSD, decrypt it and pass it on to recipient computer.

In step 760, the recipient computer may receive the file and display it in the browser.

Having fully described the preferred embodiments, other equivalent or alternative methods of enabling internet access to information hosted on a CSD according to the present invention will be apparent to those skilled in the art. The invention has been described above by way of illustration, and the specific embodiment disclosed is not intended to limit the invention to the particular forms disclosed. For example, the embodiments described in the foregoing were directed to providing clear ideas about the preferred modes, including the best mode, of making and using the present invention; however, in alternate embodiments, those skilled in the art may implement the invention using various other means without deviating from the central idea of the invention. The invention therefore covers all modifications, equivalents, and alternatives falling within the spirit and scope of the following claims.

1. A method for enabling internet access to information hosted on a CSD, the method comprising:
a server registering a CSD by assigning to the CSD a CSD ID, the CSD connected over a network to the server and the information about all registered CSDs being maintained in a CSD database residing on the server;
creating a unique resource locator for a file hosted on the CSD, the unique resource locators and other pertinent information about all files hosted from the CSD being stored in a registry file residing on the CSD;
the CSD identifying itself to the server using the CSD ID and establishing a communication channel with the server;
a web browser in a recipient computer sending the unique resource locator of the file to the server, the recipient computer connected over the network to the server;
the server forwarding the unique resource locator of the file to the CSD;
the CSD sending the hosted file corresponding to the received unique resource locator to the server; and
the server forwarding the file to the web browser in the recipient computer.

2. The method of claim 1 wherein the CSD is a computer.

3. The method of claim 1 wherein the CSD is a storage device attachable to a computer.

4. The method of claim 1, further comprising:
a crawler obtaining the files hosted on the CSDs registered with the server;
an indexer indexing the obtained files to create an indexed database; and
a search query engine searching the indexed database to return results in response to a search string entered by a user.

5. The method of claim 1, further comprising:
using a load balancer to route communication between a plurality of CSDs and a plurality of servers; and
using a load balancer to route communication between a plurality of recipient computers and a plurality of servers.

6. The method of claim 1, wherein communication between the server and the CSDs is managed securely by using one or more of (a) public-private key pairs, (b) a handshake server program residing on the server; and (c) a CSD program residing on the CSDs.

7. The method of claim 1, wherein access to the hosted files can be regulated dynamically.

8. A system for enabling internet access to information hosted on a CSD, the system comprising:
a CSD hosting one or more files for allowing others to access the files over an internet;
a server connected to the CSD over the internet and having a handshake server program for managing communication with the CSDs;
a recipient computer connected to the server over the internet, the recipient computer having a web browser and sending a unique resource locator of a file to the server;
a CSD program residing on the CSD for one or more of (a) managing communication with the server, (b) generating unique resource locators for the hosted files, and (c) maintaining a record of all the hosted files in a registry file residing on the CSD; and
a CSD database residing on the server and including records of all the CSDs registered with the server.

9. The system of claim 8 wherein the CSD is a computer.

10. The system of claim 8 wherein the CSD is a storage device attachable to a computer.

11. The system of claim 8, further comprising:
a crawler for obtaining the files hosted on the registered CSDs;
an indexer for indexing the obtained files to create an indexed database; and
a search query engine for searching the indexed database to return results in response to a search string entered by a user.

12. The system of claim 8, further comprising:
a load balancer for routing communication between a plurality of CSDs and a plurality of servers; and
a load balancer for routing communication between a plurality of recipient computers and a plurality of servers.

13. A computer-readable medium including instructions for enabling internet access to information hosted on a CSD, the instructions comprising:
a server registering a CSD by assigning to the CSD a CSD ID, the CSD connected over a network to the server and the information about all registered CSDs being maintained in a CSD database residing on the server;
creating a unique resource locator for a file hosted on the CSD, the unique resource locators and other pertinent information about all files hosted from the CSD being stored in a registry file residing on the CSD;
the CSD identifying itself to the server using the CSD ID and establishing a communication channel with the server;
a web browser in a recipient computer sending the unique resource locator of the file to the server, the recipient computer connected over the network to the server;
the server forwarding the unique resource locator of the file to the CSD;
the CSD sending the hosted file corresponding to the received unique resource locator to the server; and
the server forwarding the file to the web browser in the recipient computer.

14. The computer-readable medium of claim 13, wherein the CSD is a computer.

15. The computer-readable medium of claim 13, wherein the CSD is a storage device attachable to a computer.

16. The computer-readable medium of claim 13, further comprising:
a crawler obtaining the files hosted on the CSDs registered with the server;
an indexer indexing the obtained files to create an indexed database; and
a search query engine searching the indexed database to return results in response to a search string entered by a user.

17. The computer-readable medium of claim 13, further comprising:
using a load balancer to route communication between a plurality of CSDs and a plurality of servers; and
using a load balancer to route communication between a plurality of recipient computers and a plurality of servers.

18. The computer-readable medium of claim 13, wherein communication between the server and the CSDs is managed securely by using one or more of (a) public-private key pairs, (b) a handshake server program residing on the server; and (c) a CSD program residing on the CSD.

19. The computer-readable medium of claim 13, access to the hosted files can be regulated dynamically.
